(19) United States
(12) Patent Application Publication
(10) Pub. No.: US 2010/0097691 A1
(43) Pub. Date: Apr. 22, 2010

(54) SPIN-COATED POLYMER MICROCAVITY FOR LIGHT EMITTERS AND LASERS

(75) Inventors: Vinod M. Memon, Princeton, NJ (US); Nikesh V. Valappil, Forest Hills, NY (US)

Correspondence Address: Research Foundation of the City University of New;c/o Darby & Darby P.C., P.O. Box 770, Church Street Station, New York, NY, 10008-0770, US

(73) Assignee: Research Foundation of the City University of New York, New York, NY (US)

(21) Appl. No.: 12/443,284

(22) PCT Filed: Sep. 28, 2007
(86) PCT No.: PCT/US07/21089

§ 371 Date: Mar. 27, 2009

Related U.S. Application Data
(60) Provisional application No. 60/847,706, filed on Sep. 28, 2006.

(51) Int. Cl. H01S 3/08

(52) U.S. Cl. 359/346

(57) ABSTRACT

A spin-coated polymer microcavity for light emitters and lasers producing enhancement of spontaneous emission rate from colloidal CdSe/ZnS core/shell quantum dots embedded in a one dimensional polymer microcavity structure at room temperature. The polymer microcavity structures are fabricated using spin coating. Alternating layers of polymers of two different refractive indices were stacked to form the Distributed Bragg reflectors (DBRs). To achieve high reflectivity, the polymers for the DBR structures were chosen so that they have a relatively high refractive index ratio. The high and low refractive index polymers chosen were poly-N(vinylcarbazole) (PVK) and poly acrylic acid (PAA), with refractive indices of 1.683 and 1.420 at 600 nm, respectively. Thin films of quarter wavelength thickness of the two polymers are alternately spin coated on a glass substrate to make the DBR structures. Greater than 90% reflectivity is obtained using ten periods of the structure. A PVK cavity layer of λ thickness embedded with CdSe/ZnS core/shell quantum dots is sandwiched between two of these DBRs to form the entire microcavity structure. The bottom and top DBRs comprise ten and five periods, respectively.

### BACKGROUND OF THE INVENTION

1. Field of the Invention

The embodiments of the present invention relate to a spin-coated polymer, and more particularly, the embodiments of the present invention relate to a spin-coated polymer microcavity for light emitters and lasers.

2. Description of the Prior Art

### Spin Coating

Spin coating is a known process for forming a layer of dispensed material on a rotating surface using the centrifugal force on the dispensed material. Typically, a substrate is held in a chuck, with a surface-to-be-coated in a horizontal orientation. The chuck then spins causing the surface-to-be-coated to rotate at a predetermined speed, and a dispenser then dispenses a predetermined amount of coating material in liquid form close to the center of the rotation.

The rotation imposes a centrifugal force on the coating material forcing the mass of coating material to be pushed outwards away from the center of rotation towards the edges of the surface to be coaled. As the coating material moves from the center to the edges, some of the coating material adheres to the surface and some of the coating material continues to flow outwards. In this way, a layer of coating material is formed over the surface to be coated. Excess coating material is either thrown off the edges or forms a bead along the edges. The coating material contains solvent that begins to evaporate as soon as the coating material is dispensed.

Numerous innovations for spin-coating devices have been provided in the prior art, for example:

U.S. Pat. No. 6,616,758 issued to Hung et al. on Sep. 9, 2003 in class 118 and subclass 52 teaches an apparatus for spin coating, including a rotatable cover plate assembly having a cavity and a rotatable base plate assembly having a cavity with a semiconductor wafer mounted therein. The cover plate assembly comes down onto the base plate assembly enclosing the semiconductor wafer and a dispenser in a chamber formed by the cavities. The cover and base plates are rotated as a single assembly, and coating material is dispensed by the dispenser onto the semiconductor wafer. A flow regulator coupled via an exhaust manifold controls the rate of evaporation of solvent from the dispensed coating material.

U.S. Pat. No. 6,716,285 issued to Weyburne et al. on Apr. 6, 2004 in class 118 and subclass 52 teaches a spin coating apparatus and method of manufacturing, incorporating a perforated sheet located above the substrate in a manner to control solvent evaporation tending to occur in the coating vessel when the chuck is rotated without introducing additional airflow complications. The distance between the substrate surface and the perforated sheet, and the number, distribution, and size of the perforations in the perforated sheet can be adjusted to optimize the uniformity of film thickness coating the substrate. The result is reduced substrate and room contamination and enhanced coating uniformity.

### Distributed Bragg Reflector

A distributed Bragg reflector (DBR) is a periodic grating that can be monolithically formed on a substrate from alternating layers of differing index of refraction materials. DBRs have applications in various optic devices, in part because DBRs can achieve a high reflectivity in a relatively compact space. Further, DBRs can be tested immediately after fabrication on a substrate, unlike a crystalline reflector that must be cleaved prior to testing. Examples of devices that have incorporated DBRs include tunable optic filters, tunable detectors, and surface emitting lasers including vertical cavity surface emitting lasers (VCSEL).

The reflectivity of a DBR is a function of both its geometry and the relative difference between the index of refraction of the layers. The relative difference in the index of refraction of two materials is referred to as the index contrast. Generally, the reflectivity increases as the index contrast between layers increases and as the number of layers of the DBR increases. Also, the stop band width of the DBR increases as the index contrast increases.

Numerous innovations for distributed Bragg reflectors have been provided in the prior art, for example:

U.S. Pat. No. 6,947,217 issued to Corzine et al. on Sep. 20, 2005 in class 359 and subclass 584 teaches a distributed Bragg reflector and a method of fabricating it incorporating a support for supporting the gaps against collapse. The method includes forming a plurality of alternating structure and sacrificial layers on a substrate. The structure and sacrificial layers are etched into at least one mesa protruding from the substrate. A support layer is formed on the at least one mesa leaving a portion of the structure and sacrificial layers exposed. At least a portion of at least one of the exposed sacrificial layers is etched from between the structure layers to form gaps between the structure layers.

### Photonic Crystals

1D photonic crystals have been fabricated using inorganic dielectric materials using techniques like vacuum evaporation or sputtering. Photonic crystals using organic materials are fabricated using self-assembly of block copolymers, and spin coating. While polymeric microcavities have been fabricated for realizing ultrafast switches, they have not been used for developing surface emitters.

### Disadvantages

The disadvantages of this existing technology include the need for many layers for high reflectivity of the DBR mirror, poor control of the periodic structure, low contrast of the refractive indices of the dielectric materials, and the requirement for expensive techniques to fabricate the microcavities.

### SUMMARY OF THE INVENTION

Thus, an object of the embodiments of the present invention is to provide a spin-coated polymer microcavity for light emitters and lasers that avoids the disadvantages of the prior art.

Briefly stated, another object of the embodiments of the present invention is to provide a spin-coated polymer microcavity for light emitters and lasers producing enhancement of spontaneous emission rate from colloidal CdSe/ZnS core/shell quantum dots embedded in a one dimensional polymer microcavity structure at room temperature. The polymer microcavity structures are fabricated using spin coating. Alternating layers of polymers of two different refractive indices were stacked to form the Distributed Bragg reflectors (DBRs). To achieve high reflectivity, the polymers for the DBR structures were chosen so that they have a relatively high refractive index ratio. The high and low refractive index polymers chosen are poly-N(vinylcarbazole) (PVK) and poly acrylic acid (PAA), with refractive indices of 1.683 and 1.420 at 600 nm, respectively. Thin films of quarter wavelength thickness of the two polymers are alternately spin coated on a glass substrate to make the DBR structures. Greater than 90% reflectivity is obtained using ten periods of the structure. A PVK cavity layer of λ thickness embedded with CdSe/ZnS core/shell quantum dots is sandwiched between two of these DBRs to form the entire microcavity structure. The bottom and top DBRs comprise ten and five periods, respectively.

The novel features considered characteristic of the embodiments of the present invention are set forth in the appended claim. The embodiments of the present invention themselves, however, both as to their construction and their method of operation together with additional objects and advantages thereof will be best understood from the following description of the specific embodiments when read and understood in connection with the accompanying drawings.

### BRIEF DESCRIPTION OF THE DRAWINGS

The figures of the drawing are briefly described as follows:

FIG. 1 is a diagrammatic cross sectional view of the microcavity structure of the embodiments of the present invention;

FIG. 2 is a graph of the normalized reflectivity spectrum showing the stop band of the bottom DBR;

FIG. 3 is a graph of the reflectivity spectrum of the CdSe/ZnS core/shell quantum dots embedded microcavity; and

FIG. 4 is a graph of the photoluminescence spectra of the CdSe/ZnS core/shell quantum dots embedded in a microcavity.

### DETAILED DESCRIPTION OF THE PREFERRED EMBODIMENTS

### Methodology

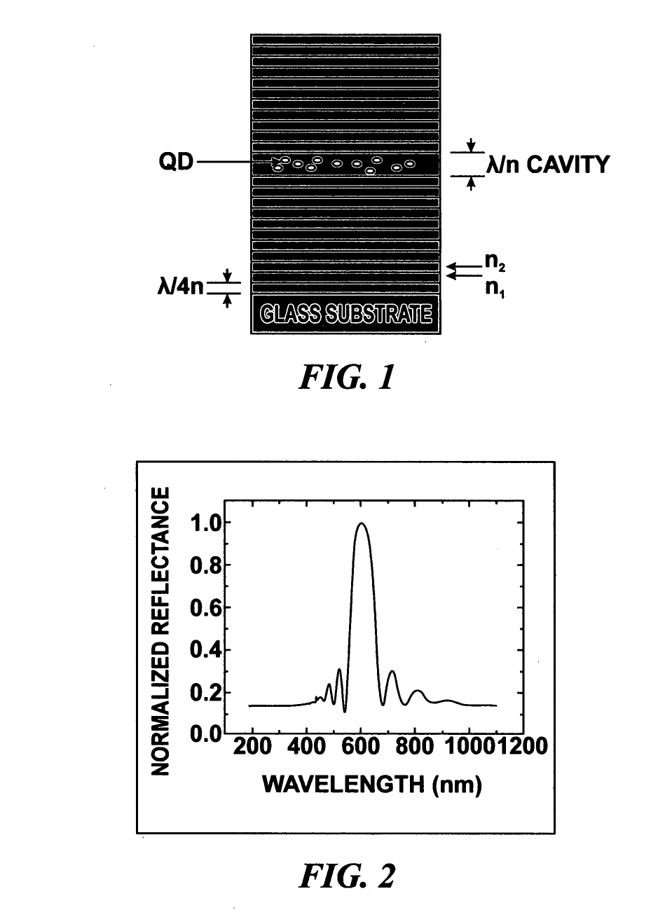

The one dimensional polymer microcavity structure was fabricated by spin coating polymers of different refractive indices on a glass substrate. The microcavity structure comprises a cavity sandwiched between two Distributed Bragg reflectors (DBRs) as shown in FIG. 1, which is a diagrammatic cross sectional view of the microcavity structure of the embodiments of the present invention. Alternating layers of polymers of two different refractive indices were stacked to form the DBRs. The bottom and top DBRs comprise ten and five periods, respectively.

To achieve high reflectivity, the polymers for the DBR structures were chosen so that they have a relatively high refractive index ratio. The high and low refractive index polymers chosen were poly-N(vinylcarbazole) (PVK) and poly(acrylic acid) (PAA), with refractive indices of 1.683 and 1.420 at 600 nm, respectively. Another important criterion for choosing these polymers was that the solvent of one polymer does not dissolve the other polymer. PVK is soluble in non-polar solvents like toluene or chlorobenzene but polar solvents like water or alcohol it is not, whereas PAA is soluble in alcohol but not in chlorobenzene.

The polymers PVK and PAA with concentration of 0.28×10⁻⁴ M and 3.12×10⁻² M, respectively, are spin coated at 4000 rpm and 6000 rpm, respectively. Thin films of quarter wavelength thickness of the two polymers are alternately spin coated on a glass substrate to make the DBR structure. The thickness of the layers is controlled by adjusting the spin speed and concentration. A PVK cavity layer of λ thickness embedded with CdSe/ZnS core/shell quantum dots is sandwiched between two such DBRs to form the entire microcavity structure. The cavity of λ/n thickness is obtained by spin coating the CdSe/ZnS quantum dots dispersed in the PVK solution at 3000 rpm. The CdSe/ZnS quantum dots dispersed in hexane (2.2 mg/ml) was purchased from Evident technologies and have an emission wavelength peak at 615 nm. The concentration of the quantum dots in PVK is optimized to obtain the maximum emission intensity, which is found to be 25% v/v of CdSe/ZnS quantum dots in 0.33×10⁻⁴ M PVK solution.

Another DBR consisting of five periods is grown on top of the cavity to form the complete microcavity structure. It should be noted that the technique described can be easily adapted to any other polymer system as long as the solvent for one polymer does not dissolve the other.

While colloidal quantum dots have been embedded in the spin-coated microcavity structure, it is to be understood that any fluorescent entity can in principle be embedded in the microcavity. Possible candidates include fluorescent molecules, semiconducting quantum dots of any material, e.g., PbSe, PbS, CdS, ZnO, InP, etc., and nanowires, e.g., ZnO, ZnS, CdSe, etc.

Fabricating the microcavities is not limited to utilizing only the two polymers PVK and PAA, but rather can utilize any two polymers whose solvents do not disolve each other.

### Results

The embodiments of the present invention provide:
Excellent reflectivity of the polymer-based DBR mirrors with very few periods.
Good control of the film thickness due to using spin-coating.
Low cost and ease of manufacture of the polymer microcavities making them highly attractive for the production environment.

The versatility of the embodiments of the present invention lies in the wavelength-independent processing technique that spin coating permits. Due to this capability, the embodiments of the present invention provide highly useful and attractive schemes for large scale production of light emitters and lasers. Additionally, spin coating also permits the development of large-area emitters suitable for display technology.

Enhanced spontaneous emission was observed from the quantum dots embedded in the microcavity.

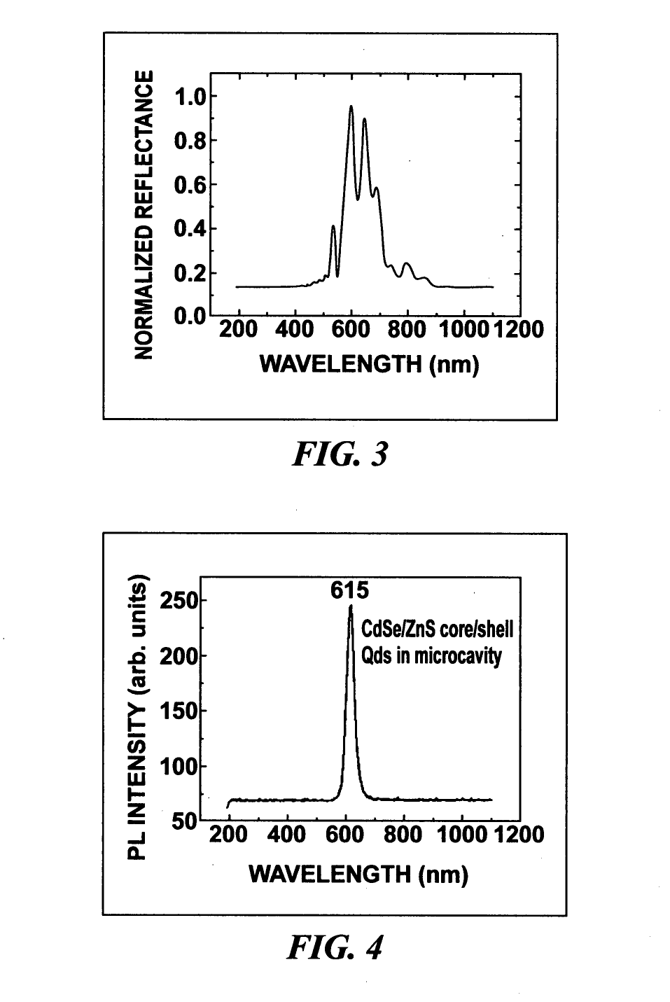

FIG. 2, which is a graph of the normalized reflectivity spectrum showing the stop band of the bottom DBR, shows the normalized reflectivity of the bottom DBR. Greater than 90% reflectivity is obtained using ten periods of the structure. The reflectivity spectra of the entire microcavity demonstrating the cavity mode, i.e., the normal incidence transmission spectrum of the entire structure, is shown in FIG. 3, which is a graph of the reflectivity spectrum of the CdSe/ZnS core/shell quantum dots embedded microcavity. A clear cavity mode is observed within the stop band. The line width of the cavity mode is ˜94 meV and is aligned with the peak emission wavelength of the quantum dots.

Photoluminescence (PL) spectra of the bare quantum dots, as well as the QDs embedded in the microcavity were carried out at room temperature, i.e., photoluminescence measurements were carried out on the microcavity structure. The CdSe/ZnS core/shell quantum dots embedded in the microcavity show the luminescence peak at 615 nm, as shown in FIG. 4, which is a graph of the photoluminescence spectra of the CdSe/ZnS core/shell quantum dots embedded in a microcavity. The quantum dots did not show any perceivable degradation in their optical properties when embedded in the polymer host matrix (PVK). The luminescence line width of the bare quantum dots and the QDs embedded in the microcavity are 93 meV and 87 meV, respectively.

### Conclusions

The microcavity structures are fabricated using spin coating. Alternating layers of polymers of two different refractive indices were stacked to form the distributed Bragg reflectors. A cavity layer of λ thickness embedded with CdSe/ZnS core/shell quantum dots was sandwiched between two of these DBRs to form the entire microcavity structure.

The embodiments of the present invention pertain to the development of a. polymeric microcavity structure for developing high-efficiency light emitters using spin coating. Spin coating is an inexpensive fabrication technique suitable for large scale production. The versatility of the embodiments of the present invention lies in the wavelength-independent processing technique that spin coating permits. Due to this capability, it will provide a highly useful and attractive scheme for large scale production of light emitters and lasers. Additionally, spin coating also permits the development of large area emitters suitable for display technology. Furthermore, any fluorescent entity can be embedded in the microcavity.

The spin coating technique can be adapted to any type of substrate, and hence, can be extended to flexible substrates. This will lead to the development of flexible emitters and lasers, which are important from the standpoint of display applications.

It will be understood that each of the elements described above or two or more together may also find a useful application in other types of constructions differing from the types described above.

While the embodiments of the present invention have been illustrated and described as embodied in a spin-coated polymer microcavity for light emitters and lasers, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A spin-coated polymer microcavity for light emitters and lasers, comprising:
a) a pair of distributed Bragg reflectors; and
b) a microcavity structure;
wherein said microcavity structure is sandwiched between said pair of distributed Bragg reflectors;
wherein said pair of distributed Bragg reflectors comprise alternating layers of polymers of two different refractive indices;
wherein said polymers have a relatively high refractive index ratio for achieving high reflectivity; and
wherein said microcavity structure Comprises a layer of said polymer having a higher refractive index than that of the other polymer and being embedded with quantum dots.
